(19) United States
(12) Patent Application Publication
(10) Pub. No.: US 2011/0187075 A1
(43) Pub. Date: Aug. 4, 2011

(54) WHEELCHAIR DRIVING APPARATUS

(76) Inventor: RONG-JEN WU, TAOYUAN (TW)

(21) Appl. No.: 12/978,853

(22) Filed: Dec. 27, 2010

(30) Foreign Application Priority Data
Jan. 27, 2010 (TW) 099201617

(51) Int. Cl. B62M 1/04

(52) U.S. Cl. 280/244

(57) ABSTRACT

An improved wheelchair driving apparatus includes a driving rod pivotally installed at an axle of each driving wheel on both sides of a chair frame, and an external end of the driving rod being extended from an external rim of the driving wheel, a brake module installed at a position corresponding to the driving wheel and provided for fixing and releasing the driving wheel by a hand brake, such that users can release the driving wheel through the brake module by both hands to freely swing the driving rod back and forth or fix the brake module to the driving wheel through the hand brake to swing the driving rod back and forth to drive the driving wheel to move forward or backward, such that the wheelchair can be operated and controlled in an easier, more, conveniently, cleaner, less effort and safer manner.

### BACKGROUND OF THE INVENTION

1. Field of the Invention

The present invention relates to an improved wheelchair driving apparatus, and more particularly to a wheelchair driving apparatus that comes with a simple assembly and an easy-to-use and convenient feature and makes the control and operation of a wheelchair simpler, easier, cleaner, faster, less effort and safer.

2. Description of the Related Art

With reference to FIG. 1 for a conventional wheelchair, the wheelchair comprises a chair frame 10, a driving wheel 20 separately installed at rear ends of both sides of the chair frame 10, an auxiliary wheel 30 having a diameter smaller than the diameter of the driving wheel 20 separately installed at front ends of both sides of the chair frame 10, and a driving ring 40 separately installed on external sides of the left and right driving wheels 20 along the wheel frame. During use, a user sitting on the chair frame 10 steps on pedals 11 by both legs and holds the driving rings 40 by both hands, such that both hands can push and pull the driving rings 40 back and forth to roll the left and right driving wheels 20 directly. With the assistance of the left and right auxiliary wheels 30, the wheelchair can move forward and backward or make a turn. The conventional wheelchair adopts the method of pushing and pulling the driving rings 40 by both hands to achieve the effect of operating and controlling the wheelchair. However, such method has the following disadvantages:

1. Since both hands hold the driving rings to push or pull the driving rings, and the driving ring is integrated with the driving wheel as a whole, therefore it takes much effect for users to push and pull the driving wheels directly by both hands, particularly for the use on a slope.

2. Since the driving ring is mounted on the external rim of the driving wheel, dusts, dirty substances and water may be spluttered onto the periphery of the driving wheel easily when the driving wheel is rotated, and thus making both hands dirty.

3. Since users have to cross the driving wheels to hold the driving rings by both hands respectively, sleeves may be soiled or even damaged easily by frictions produced by the driving wheel, and the arms across the driving wheels may be injured by the friction produced by the rotation of the driving wheels,

### SUMMARY OF THE INVENTION

It is a primary objective of the present invention to overcome the shortcomings of the prior art by providing an improved wheelchair driving apparatus, such that the wheelchair can be operated and controlled in a simpler, easier, cleaner, faster, less effort and safer fashion.

To achieve the foregoing objective, the present invention provides a wheelchair driving apparatus comprising a driving rod pivotally installed at an axle of a driving wheel on each of both sides of a chair frame, and an external end of the driving rod being extended from an external rim of the driving wheel, a brake module installed at a position corresponding to the driving wheel and provided for fixing and releasing the driving wheel by a hand brake, such that users can release the driving wheel through the brake module by both hands to freely swing the driving rod back and forth or fix the brake module to the driving wheel through the hand brake to swing the driving rod back and forth to drive the driving wheel to move forward or backward, such that the wheelchair can be operated and controlled in an easier, more, conveniently, cleaner, less effort and safer manner.

The purpose, technical characteristic and effects of the present invention will become apparent with the detailed description of preferred embodiments and the illustration of related drawings.

### BRIEF DESCRIPTION OF THE DRAWINGS

FIG. 1 is a schematic perspective view of a conventional wheelchair;

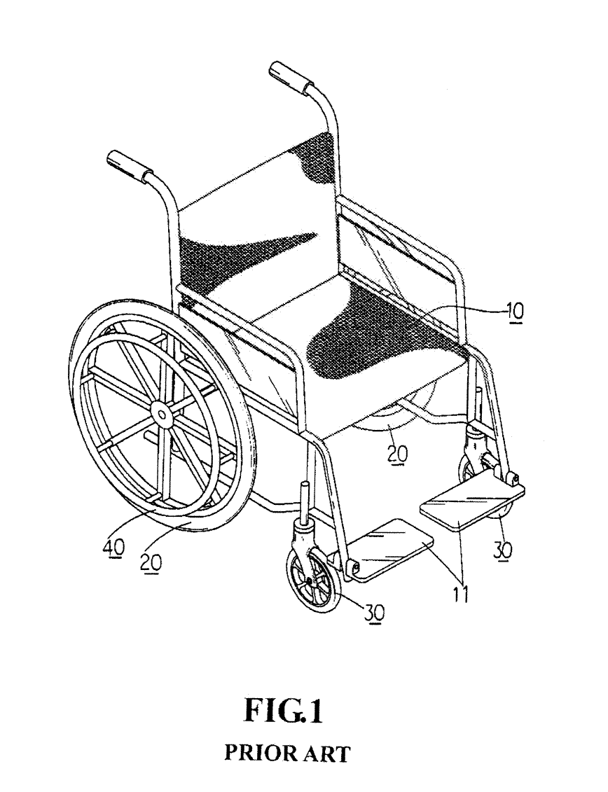

FIG. 2 is a schematic perspective view of a wheelchair driving apparatus installed to a wheelchair in accordance with a preferred embodiment of the present invention;

FIG. 3 is a front view of a wheelchair driving apparatus installed to a wheelchair in accordance with a preferred embodiment of the present invention; and

FIG. 4 is a side view of an operation in accordance with a preferred embodiment of the present invention.

### DETAILED DESCRIPTION OF THE PREFERRED EMBODIMENTS

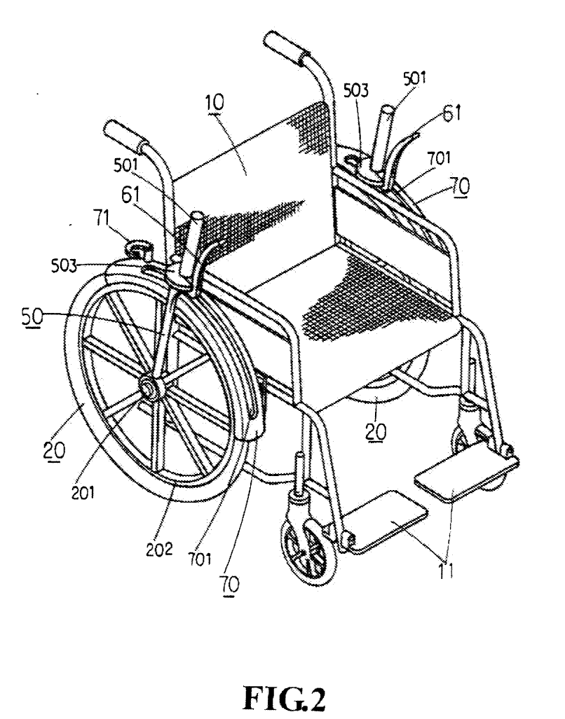

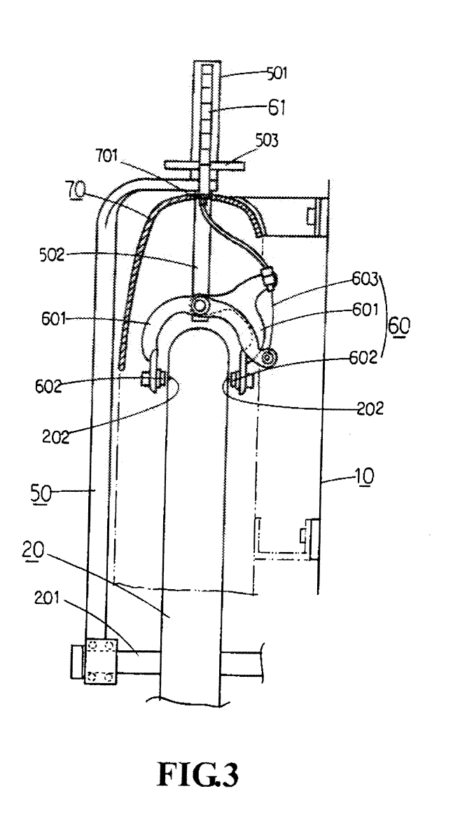

With reference to FIGS. 2 and 3 for an improved wheelchair driving apparatus of the present invention, a driving rod 50 is pivotally installed at an axle 201 of each driving wheel 20 on both sides of a chair frame 10 of a wheelchair, and the driving rod 50 can be swung back and forth freely with respect to an axial point of the axle 201, and an external end of the driving rod 50 is extended from an external rim of the driving wheel 20, and a handle 501 and a brake module 60 are installed thereon, wherein the brake module 60 is corresponsive to the driving wheel 20 and controlled by the hand brake 61 installed on a side of the handle 501 for fixing and releasing the driving wheel 20. The brake module 60 is installed in the same way as a bicycle, and comprises left and right swing arms 601 pivotally installed to an extended arm 502 of the driving rod 50, a brake shoe 602 installed at an end of each of the left and right swing arms 601 and corresponding to the driving wheel frame 202, and a steel rope 603 dragged and coupled at the hand brake 61, such that the hand brake 61 can be operated to control the brake shoe 602 to fix and release the driving wheel 20.

The hand brake 61 is installed adjacent to the handle 501 of the driving rod 50, and a support portion 503 is disposed at the bottom of the handle 501, such that a user can hold the handle 501 by both hands, and the support portion 503 is provided for supporting and controlling the hand brake 61.

In addition, a fender 70 is mounted onto an external rim of an upper half of each of the left and right driving wheels 20 and fixed to the chair frame 10, and a longitudinal through slot 701 is formed on the circumferential surface of the fender 70 and provided for passing through the extended arm 502 of the driving rod 50, such that the upper half of the driving wheel 20 can be covered to achieve the effect of preventing splash from water and dirt and a part of clothes from being caught, and the extended arm 502 of the driving rod 50 can be swung freely in the through slot 701.

A latch 71 is installed at an end of the fender 70 for latching the driving rod 50.

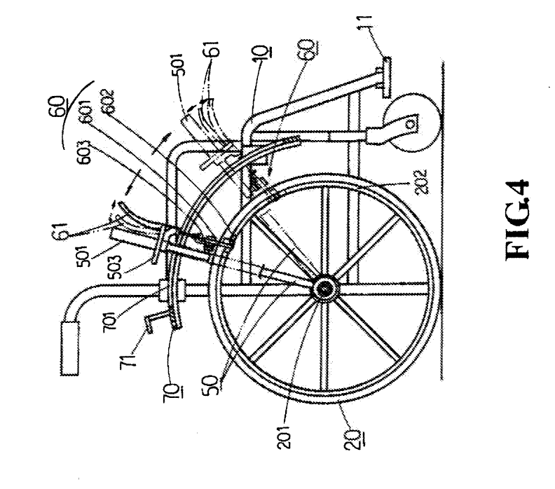

In the foregoing assembly of the present invention as shown in FIG. 4, when a user sits on the chair frame 10 and steps pedals 11 by both legs and holds handles 501 at both ends of the left and right driving rods 50 by both hands. The other end of the left and right driving rods is pivotally installed at the axle 201 of each of the left and right driving wheels 20, such that the left and right driving rods 50 can be swung back and forth freely by both hands of the user with respect to the turning point of the axle 201. In addition, the hand brake 61 installed adjacent to the handle 501 of the driving rod 50 can be operated by the user's hands to drive the brake shoe 602 of the brake module 60 to fix and release the driving wheel 20, so that if the user wants to drive the wheelchair forward, the user simply operates the hand brake 61 to clamp and fix the brake module 60 onto the driving wheel 20 and move the driving rod 50 back and forth, such that the clamped driving wheel 20 will move back and forth with the swings of the driving rod 50 to achieve the effect of driving the wheelchair forward.

On the other hand, when it is necessary to operate the hand brake 61 to drive the brake module 60 to release the driving wheel 20, the user moves the driving rod 50 back and forth to any appropriate position, so that the hand brake 61 together with the brake module 60 will turn the driving wheel 20 to any angle and position for the fixing and driving motions, such that if the driving rod 50 is moved back and forth continuously and the hand brake 61 controls the brake module 60, the left and right driving wheels 20 can be moved successfully to achieve the effect of driving the wheelchair.

If it is necessary to make a turn of the wheelchair, the user simply fix the brake module 60 to one of the driving rods 50 of the corresponding driving wheel 20, so that the driving rod 50 will remain still, and the other hand of the user keeps moving the corresponding driving rod 50 to operate the brake module 60 of the other driving wheel 20 in order to make a right or left turn naturally and successfully.

Since the fender 70 mounted onto the chair frame 10 can cover the upper half of the driving wheel 20 without hindering the swing operation of the driving rod 50, therefore the user can hold the handle 501 of the driving rod 50 by both hands for moving the driving rod 50 back and forth, not only preventing palms or sleeves from being touched or caught by the driving wheel 20, but also providing the safety effects of preventing the rider from being injured or the rider's clothes from being caught and damaged.

Since the support portion 503 is installed at the bottom of the handle 501 of the driving rod 50 for supporting the user's hands, therefore after the user holds the handle 501 by both hands, the user's hand will not get tired easily, particularly for the swing operation. Obviously, such arrangement can improve the performance of applying forces. With the latching operation of the latch 71 installed at the fender 70, the driving rod 50 can be fixed at a position, when it is not in use, so that the wheelchair can be stored and transported easily and conveniently.

After the user sits on the chair frame 10, the user can use both hands to move the driving rod 50 back and forth and control the hand brake 61 to drive the brake module 60 to fix and release the driving wheel 20 to achieve the effect of driving, turning, or stopping the wheelchair. Obviously, the present invention provides a simple, easy, and convenient effect. The driving rod 50 together with the handle 501 can be operated directly to provide a convenient arm of force, such that a person who is cripple or inconvenient to walk can operate the wheelchair with less effort and a better efficiency. In addition, the fender 70 is mounted onto the external rim of the upper half of the driving wheel 20, and the handle 501 of the driving rod 50 is installed at the external periphery of the fender 70, so that the user can hold and control the handle 501 to achieve the effects of preventing a part of clothes from being caught by the driving wheel 20 as well as providing a safety effect.

While the invention has been described by means of specific embodiments, numerous modifications and variations such as a change of numeric values or a replacement of an equivalent component could be made thereto by those skilled in the art without departing from the scope and spirit of the invention set forth in the claims.

What is claimed is:

1. An improved wheelchair driving apparatus, comprising a driving rod 50 pivotally installed at each driving wheel axle 201 on both sides of a wheelchair frame 10 and selectively swung back and forth, a handle 501, a hand brake 61 and a brake module 60 installed at the other end of the driving rod 50, and the brake module 60 being controlled by the hand brake 61 to selectively fix and release the driving wheel 20.

2. The improved wheelchair driving apparatus of claim 1, wherein the driving rod 50 includes an extended arm 502 for installing the brake module 60, and the brake module 60 includes left and right swing arms 601 disposed on both sides of the driving wheel 20 respectively, and a brake shoe 602 installed separately at both ends corresponding to a driving wheel frame 202, and the other end being driven by a steel rope 603 and coupled to the hand brake 61.

3. The improved wheelchair driving apparatus of claim 1, wherein the driving rod 50 includes a support portion 503 disposed at the bottom of the handle 501.

4. The improved wheelchair driving apparatus of claim 1, further comprising a fender 70 installed on both sides of the chair frame 10 for covering the upper half of the driving wheel 20, and a longitudinal through slot 701 formed on a circumferential surface of the fender 70 for passing through the extended arm 502 of the driving rod 50.

5. The improved wheelchair driving apparatus of claim 4, wherein the fender 70 includes a latch 71 installed at an end of the fender 70 for positioning the driving rod 50.
